(19) United States
(12) Patent Application Publication
(10) Pub. No.: US 2026/0218071 A1
(43) Pub. Date: Jul. 30, 2026

(54) SYSTEM AND METHOD FOR PRODUCING HYDROGEN FROM FEEDSTOCK

(71) Applicant: SYNTHEC FUELS GMBH, Düsseldorf (DE)

(72) Inventor: Walter VANSELOW, Ratzeburg (DE)

(21) Appl. No.: 19/144,157

(22) PCT Filed: Dec. 27, 2023
(86) PCT No.: PCT/EP2023/087860

§ 371 Date: Jun. 27, 2025

(30) Foreign Application Priority Data
Dec. 29, 2022 (DE) 10 2022 134 996.9

(51) Int. Cl. C10J 3/62; C01B 3/32; C10B 21/08; C10B 53/00; C10J 3/66; C10J 3/72; C10K 3/04

(52) U.S. Cl. CPC C10J 3/62; C01B 3/32; C10B 21/08; C10B 53/00; C10J 3/66; C10J 3/723; C10K 3/04; C01B 2203/0205; C10J 2300/0946; C10J 2300/1207; C10J 2300/1223; C10J 2300/1246; C10J 2300/1618

(57) ABSTRACT

The present disclosure relates to a system for producing hydrogen from feedstock and a method thereof. The system comprises a first chamber adapted to thermally decompose the feedstock, and a second chamber adapted to receive a first portion of the gaseous stream and to receive a first portion of the solids stream to form a reactants combination. The second chamber adapted to partially react the reactants combination with steam to produce a product gas. The system further comprises a third chamber adapted to receive a second portion of the gaseous stream and adapted to receive a second portion of the solids stream to form a combustibles combination. The third chamber adapted to at least partially combust the combustibles combination to produce process heat for the first chamber and/or the second chamber. The system further comprises a controller adapted to adjust the composition of the reactants combination and of the combustibles combination.

### TECHNICAL FIELD

The present disclosure relates to a system for producing hydrogen from feedstock. Further, the present disclosure relates to a method for producing hydrogen from feedstock.

### BACKGROUND

It is known that the gasification of a feedstock can release a gas rich in hydrogen. The feedstock comprises organic material. The gas may also be composed of elements like carbon monoxide (CO), methane (CH4), carbon dioxide (CO2), water vapor and sulfur compounds. The feedstock may be biodegradable material that comprises a composition of carbon or carbohydrates containing substance, Hydrogen, Nitrogen, Calcium etc. The biodegradable material or biomass composition is generally found in organic materials like wood, biodegradable plastics, pesticides, herbicides, pathogens, paints, contaminated solvents, residues from the paper and cellulose production, coal, tar, tar sand to name a few. This kind of feedstock is collected from homes, hospitals, power plants, oil refineries etc. On the other hand, non-biodegradable wastes are those that cannot be decomposed naturally. They remain on earth for thousands of years without any degradation. Some examples of the non-biodegradable wastes include but not limited to certain glasses and plastics.

Previously, either the gases or the solids were used for hydrogen generation, and the other went into combustion. These binary systems have disadvantages because the composition of the feedstock can vary. There are challenges with increasing hydrogen yield.

### OVERVIEW

Thus, there is a need to overcome drawbacks of prior art. In particular, there is a need to overcome drawbacks of conventional hydrogen generation systems that use only one of a gaseous stream or a solids stream for generation of the hydrogen. The various aspects of the present disclosure overcome drawbacks of the prior art. The following presents a simplified overview in order to provide a basic understanding of one or more aspects of the present disclosure. This overview is not an extensive overview of the present disclosure, and is neither intended to identify key or critical elements of the present disclosure, nor to delineate the scope thereof. Rather, the primary purpose of the overview is to present some embodiments of the present disclosure.

According to an aspect of the present disclosure, a system for producing hydrogen from feedstock is provided. The system comprises a first chamber adapted to thermally decompose the feedstock into a gaseous stream and a solids stream. The system further comprises a second chamber adapted to receive a first portion of the gaseous stream and to receive a first portion of the solids stream to form a reactants combination. The second chamber is further adapted to at least partially react the reactants combination with steam to produce a product gas comprising the hydrogen. The system further comprises a third chamber adapted to receive a second portion of the gaseous stream and to receive a second portion of the solids stream to form a combustibles combination. The third chamber is further adapted to at least partially combust the combustibles combination to produce process heat for the first chamber and/or the second chamber. The system further comprises a controller adapted to adjust the composition of the reactants combination and of the combustibles combination.

According to another aspect of the present disclosure, a method for extracting hydrogen from feedstock is disclosed. The method comprises performing thermal decomposition of the feedstock to decompose the feedstock into a gaseous stream and a solids stream. The method further comprises at least partially reacting a reactants combination with steam to produce a product gas comprising the hydrogen, wherein the reactants combination is composed of at least a first portion of the gaseous stream and a first portion of the solids stream. The method further comprises producing heat by at least partially combusting a combustibles combination for performing the thermal decomposition and/or for the at least partially reacting the reactants combination with steam, wherein the combustibles combination is composed of at least a second portion of the gaseous stream and a second portion of the solids stream. The method further comprises providing a sensor signal indicative of a value of a process parameter selected from the group consisting of an amount of the gaseous stream, an amount of the solids stream, and a heating value of the feedstock. The method further comprises adjusting the composition of the reactants combination and the combustibles combination based on the sensor signal.

According to yet another aspect of the present disclosure, another method for extracting hydrogen from feedstock is disclosed. The method comprises performing thermal decomposition of the feedstock to decompose the feedstock into a gaseous stream and a solids stream. The method further comprises at least partially reacting a reactants combination with steam to produce a product gas comprising the hydrogen, wherein the reactants combination is composed of at least a first portion of the gaseous stream and a first portion of the solids stream. The method further comprises producing heat by combusting a combustibles combination for performing the thermal decomposition and/or for at least partially reacting the reactants combination with steam, wherein the combustibles combination is composed of at least a second portion of the gaseous stream and a second portion of the solids stream. The method further comprises estimating a value of a process parameter selected from the group consisting of an amount of the gaseous stream, an amount of the solids stream, and a heating value of the feedstock. The method further comprises adjusting the composition of the reactants combination and the combustibles combination based on the value of the process parameter.

It is to be noted that elements of the present disclosure may be combined with each other unless specifically noted to the contrary.

This overview is submitted with the understanding that it will not be used to interpret or limit the scope or meaning of the claims. This overview is not intended to identify key features or essential features of the claimed subject matter, nor is it intended to be used as an aid in determining the scope of the claimed subject matter. Those skilled in the art will recognize additional features and advantages upon reading the following detailed description, and upon viewing the accompanying drawings.

### BRIEF DESCRIPTION OF THE DRAWINGS

FIG. 1 is a drawing that schematically illustrates a system according to some embodiments.

FIG. 2 is a flowchart that illustrates a method of gasification of feedstock according to an embodiment of the present disclosure.

FIG. 3 is a flowchart that illustrates a method of gasification of feedstock according to another embodiment of the present disclosure.

### DETAILED DESCRIPTION

Below, embodiments, implementations and associated effects are disclosed with reference to the drawings that illustrate views of some embodiments. It should be noted that views of exemplary embodiments are merely to illustrate selected features of the some embodiments. As used herein, like terms refer to like elements throughout the description.

It is to be understood that the features of various embodiments described herein may be combined with each other, unless specifically noted otherwise. In some instances, well-known features are omitted or simplified to clarify the description of the exemplary implementations. The order in which the embodiments/implementations and methods/processes are described is not intended to be construed as a limitation, and any number of the described implementations and processes may be combined.

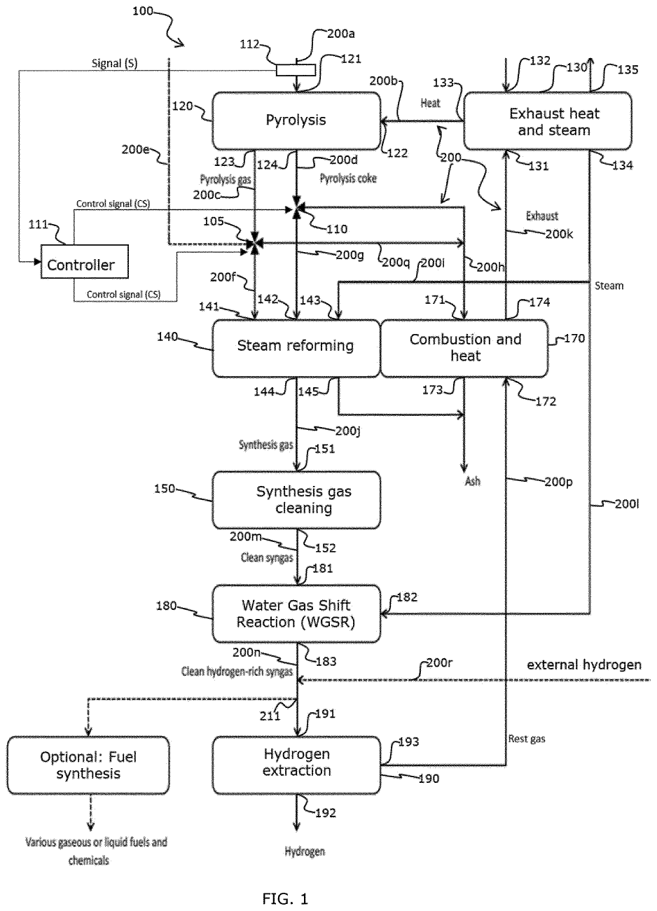

FIG. 1 is a drawing that schematically illustrates a system 100 according to an aspect of the present disclosure. According to the embodiment, the system 100 is provided for producing hydrogen from feedstock. In some embodiments, the system 100 is configured to determine a portion of the feedstock which is biodegradable waste. In some embodiments, the system 100 is configured to determine another portion of the feedstock which is non-biodegradable waste. For example, the system 100 is configured to measure the portion and/or the another portion of the feedstock. In some embodiments, the system 100 comprises a first chamber 120 configured to receive the feedstock, a second chamber 140, a third chamber 170, a heat exchanger 130 and a controller 111. In some embodiments, the controller 111 is coupled to a first flow regulator 105 and/or to a second flow regulator 110, herein also collectively referenced as flow regulators 105, 110. In some embodiments, the controller 111 is configured to estimate a ratio of the biodegradable waste in the feedstock to the non-biodegradable waste in the feedstock. In some embodiments the estimating is based on the portion of the feedstock which is biodegradable waste and/or on the portion of the feedstock which is non-biodegradable waste.

In some embodiments, the first chamber 120 is adapted to thermally decompose the feedstock into a gaseous stream and a solids stream. The gaseous stream comprises pyrolysis gases. The solids stream comprises pyrolysis coke/charcoal. The biodegradable material when thermally decomposed can produce gases and solids, mainly composed of charcoal, rich in hydrogen. The non-biodegradable material when thermally decomposed can produce gases rich in energy. In some embodiments, the system 100 is configured to perform measurement on the feedstock before, in particular right before, feeding the feedstock into the first chamber 120.

In some embodiments, the second chamber 140 is adapted to receive a first portion of the gaseous stream. Further, the second chamber 140 is adapted to receive a first portion of the solids stream. The second chamber 140 is configured for at least the first portion of the gaseous stream and the first portion of the solids stream to form a reactants combination.

In some embodiments, the second chamber 140 is configured for the gas, coke and/or other components that form the reactants combination to be reacted indiscriminately in the second chamber 140.

In some embodiments, the second chamber 140 is configured for the gas, coke and/or other components, upon having entered the second chamber 140, to arbitrarily form the reactants combination in the second chamber 140.

In some embodiments, the second chamber 140 is configured for the gas, coke and/or other components to be mixed in the second chamber 140 so as to form the reactants combination.

In some embodiments, the second chamber 140 is configured to enhance the mixing of the gas, coke and/or other components to form the reactants combination.

The second chamber 140 is further configured to react the reactants combination with steam to produce a product gas comprising the hydrogen. In some embodiments, the second chamber 140 is adapted to completely react the reactants with the steam. In some embodiments, the second chamber 140 is adapted to at least partially react the reactants with the steam. In some embodiments, the second chamber 140 is adapted to adjust an extent to which the reactants react with the steam. In some embodiments, the second chamber 140 is configured to be controlled so as to dynamically adjust the extent to which the reactants react with the steam.

In some embodiments, the third chamber 170 is adapted to receive a second portion of the gaseous stream. Further, the third chamber 170 is adapted to receive a second portion of the solids stream. The third chamber 170 is configured for at least the second portion of the gaseous stream and the second portion of the solids stream to form a combustibles combination.

In some embodiments, the third chamber 170 is configured for the gas, coke and/or other components that form the combustibles combination to be combusted indiscriminately in the third chamber 170.

In some embodiments, the third chamber 170 is configured for the gas, coke and/or other components, upon having entered the third chamber 170, to arbitrarily form the combustibles combination in the third chamber 170.

In some embodiments, the third chamber 170 is configured for the gas, coke and/or other components to be mixed in the third chamber 170 so as to form the combustibles combination.

In some embodiments, the third chamber 170 is configured to enhance the mixing of the gas, coke and/or other components to form the combustibles combination.

In some embodiments, the third chamber 170 is provided with an air inlet.

The third chamber 170 is further configured to combust the combustibles combination to produce process heat for the first chamber 120, the second chamber 140, or a combination thereof.

In some embodiments, the third chamber 170 is adapted to completely combust the reactants combination. In some embodiments, the third chamber 170 is adapted to combust at least a portion of the combustibles combination.

At least one effect of the above configuration can be that the gasification of the feedstock and the combustion of the feedstock take place within the system 100. In particular, the process heat can be used to efficiently perform the thermal decomposition of the feedstock.

In some embodiments, the first chamber 120 is configured to operate at a temperature of equal to or above 60° C. In some embodiments, the first chamber 120 is configured to operate at a temperature of equal to or above 100° C. In some embodiments, the first chamber 120 is configured to operate at a temperature of equal to or above 160° C. At least one effect can be that the first chamber can subject sugar to the pyrolysis. In some embodiments, the first chamber 120 is configured to operate at a temperature of equal to or above 200° C., for example in the range of from 200° C. to 600° C. or at least up to 300° C. In some embodiments, the first chamber 120 is configured to operate at a temperature of equal to or above 350° C., for example in the range of from 350° C. to 600° C. In some embodiments, the first chamber 120 is configured as a pyrolysis reactor. At least one effect can be that the feedstock breakdown into various states of matter. For example, the feedstock may breakdown in a solids stream, a gaseous stream, or a combination thereof.

In some embodiments, the first chamber 120 comprises a first pyrolysis inlet 121. In some embodiments, the first pyrolysis inlet 121 is configured to receive the feedstock and provide the feedstock into the first chamber 120. In some embodiments, the first chamber 120 further comprises a second pyrolysis inlet 122. The second pyrolysis inlet 122 is configured to receive process heat and provide the process heat into the first chamber 120. Thus, the process heat is used for performing thermal decomposition of the feedstock in the first chamber 120. In some embodiments, the first chamber 120 is configured to receive peptides, enzymes and/or proteins that have a catalytic effect on other components of the feedstock. For example, the first pyrolysis inlet 121 and/or another inlet can be used to feed the peptides, enzymes and/or proteins to the first chamber 120. At least one effect can be that the first chamber 120 can perform the pyrolysis at a lower temperature. Thus, energy savings can be realized.

In some embodiments, the first chamber 120 further comprises a gaseous stream outlet 123. The gaseous stream outlet 123 may be configured to release the gaseous stream of the thermally decomposed feedstock. In some embodiments, the first chamber 120 further comprises a solids stream outlet 124. In some embodiments, the solids stream outlet 124 is configured to release the solids stream of the thermally decomposed feedstock. At least one effect can be that the pyrolysis gas and the pyrolysis coke obtained from the thermal decomposition of the feedstock discharge from the first chamber 120.

In some embodiments, the system 100 further comprises a plurality of conduits 200. In some embodiments, the plurality of conduits 200 is configured to couple the first chamber 120, the second chamber 140, the third chamber 170, the flow regulators 105, 110 and other components of the system 100. For example, a conduit 200 of the plurality of conduits 200 is implemented as a tube configured to have a gas flow therethrough. In some embodiments, the tube is configured for flow of pressurized gas. For another example, another conduit of the plurality of conduits 200 is implemented as a conveyer belt configured to transport solids thereon. At least one effect can be to enable a flow of gas for use in the reactants combination and/or for use in the combustibles combination, a transport of solids for use in the reactants combination and/or for use in the combustibles combination, a transport of the combustibles combination, a flow of hot gas and with it the transport of process heat and/or a transport of the feedstock between components of the system 100 such as the first chamber 120, the second chamber 140, the third chamber 170, the flow regulators 105, 110 and/or any other chambers of the system 100.

In some embodiments, the plurality of conduits 200 comprises a conduit 200a. The conduit 200a is coupled to the first pyrolysis inlet 121. In some embodiments, the conduit 200a is configured to flow the feedstock into the first chamber 120. In some embodiments, the plurality of conduits 200 further comprises a conduit 200b. The conduit 200b is configured to couple the second pyrolysis inlet 122 to the heat exchanger 130. The first chamber 120 is configured to receive the process heat from the heat exchanger 130 by the conduit 200b. In some embodiments, the plurality of conduits 200 further comprises a conduit 200c. The conduit 200c is configured to couple the gaseous stream outlet 123 to the first flow regulator 105. The first flow regulator 105 receives the gaseous stream of the thermally decomposed feedstock through the conduit 200c. In some embodiments, the plurality of conduits 200 further comprises a conduit 200d. The conduit 200d is configured to couple the solids stream outlet 124 to the second flow regulator 110. The second flow regulator 110 is configured to receive the solids stream of the thermally decomposed feedstock through the conduit 200d. In some embodiments, the plurality of conduits 200 further comprises a conduit 200e. The conduit 200e is configured to couple the first flow regulator 105 to another source of feedstock that provides the feedstock in the liquid state or in the gaseous state to the first flow regulator 105.

In some embodiments, the controller 111 comprises circuitry configured to control the flow of fluids. In some embodiments, the controller 111 comprises one or more of electronic control circuitry, one or more electric circuit elements, one or more integrated circuits and/or one or more mechanical control elements, for example a valve, or a combination thereof. In some embodiments, the controller 111 is configured to adjust the composition of the reactants combination. In some embodiments, the controller 111 is configured to adjust the composition of the combustibles combination.

In some embodiments, the controller 111 is configured to increase, when the gaseous stream of the thermally decomposed feedstock increases relative to the solids stream of the thermally decomposed feedstock, the ratio of the first portion of the gaseous stream, wherein this first portion forms part of the reactants combination, to the second portion of the gaseous stream, wherein this second portion forms part of the combustibles combination. Likewise, the controller 111 is configured to reduce, when the solids stream of the thermally decomposed feedstock decreases relative to the gaseous stream of the thermally decomposed feedstock, the ratio of the first portion of the solids stream, wherein this first portion forms part of the reactants combination, to the second portion of the solids stream, wherein this second portion forms part of the combustibles combination.

In some embodiments, the controller 111 is configured to increase, when the gaseous stream of the thermally decomposed feedstock decreases relative to the solids stream of the thermally decomposed feedstock, the ratio of the second portion of the gaseous stream in the combustibles combination to the first portion of the gaseous stream, wherein this first portion forms part of the reactants combination. Likewise, the controller 111 is configured to reduce, when the solids stream of the thermally decomposed feedstock increases relative to the gaseous stream of the thermally decomposed feedstock, the ratio of the second portion of the solids stream, wherein this second portion forms part of the combustibles combination, to the first portion of the solids stream, wherein this first portion forms part of the reactants combination.

In some embodiments, the controller 111 is configured to increase, when the ratio of the biodegradable waste in the feedstock to the non-biodegradable waste in the feedstock increases, the ratio of the first portion of the solids stream flowing from the second flow regulator 110 to the second chamber 140 to the second portion of the solids stream flowing from the second flow regulator 110 the third chamber 170. In some embodiments, the controller 111 is configured to increase, when the ratio of the biodegradable waste in the feedstock to the non-biodegradable waste in the feedstock increases, the ratio of the second portion of the gaseous stream flowing from the first flow regulator 105 to the third chamber 170 to the first portion of the gaseous stream flowing from the first flow regulator 105 to the second chamber 140. At least one effect can be that yield of the product gas is improved.

Since biodegradable waste produces charcoal with hydrogen content that is higher than the hydrogen content in the produced gas, it is efficient to gasify the charcoal (solid portion) in the second chamber 140 and burn the gas in the third chamber 170. In some embodiments, the controller 111 is configured to increase, when the ratio of the non-biodegradable waste in the feedstock to the biodegradable waste in the feedstock increases, the ratio of the first portion of the gaseous stream flowing from the first flow regulator 105 to the second chamber 140 to the second portion of the gaseous stream flowing from the first flow regulator 105 the third chamber 170. In some embodiments, the controller 111 is configured to increase, when the ratio of the non-biodegradable waste in the feedstock to the biodegradable waste in the feedstock increases, the ratio of the second portion of the solids stream flowing from the second flow regulator 110 to the third chamber 170 to the first portion of the solids stream flowing from the second flow regulator 110 to the second chamber 140. At least one effect can be that yield of the product gas is improved. Since non-biodegradable waste produces gas with hydrogen content that is higher than the hydrogen content in the produced charcoal, it is efficient to gasify the gas in the second chamber 140 and burn the charcoal (solid portion) in the third chamber 170.

In some embodiments, the controller 111 is configured to estimate of the ratio of the biodegradable waste in the feedstock to the non-biodegradable waste in the feedstock based on data representative of an amount of biodegradable waste available for processing during a predetermined period of operation and data representative of an amount of non-biodegradable waste available for processing during the predetermined period of operation. For example, the controller 111 can be configured to estimate the ratio based on the ratio of the biodegradable waste available during a next hour of operation of a facility with the system to an amount of non-biodegradable waste available during the next hour of operation of the facility.

In some embodiments, the controller 111 is configured to estimate a change of a value of a process parameter. In some embodiments, the process parameter is selected from a group consisting of an amount of the gaseous stream, an amount of the solids stream, and a heating value of the feedstock. In some embodiments, the controller 111 is further adapted to perform the adjusting of the composition of the reactants combination and/or the composition of the combustibles combination based on the change of the process parameter value. In some embodiments, the controller 111 is further adapted to perform the adjusting of the composition of the reactants combination and/or the composition of the combustibles combination based on a rate of change of the process parameter value. In some embodiments, the controller 111 is configured to select another process parameter based on the process parameter value. In some embodiments, the controller 111 is further configured to estimate another process parameter value of the another process parameter. For example, reflectivity of the feedstock could be one process parameter while weight of feedstock could be another process parameter. The controller 111 can be configured to switch from using weight of feedstock as a basis for the adjusting to using reflectivity of the feedstock, if a first predetermined condition is met, for example, if weight of the feedstock falls below a predetermined weight threshold value. Further, the controller 111 can be configured to switch from using reflectivity of the feedstock to using weight of the feedstock as a basis for the adjusting, if a second predetermined condition is met, for example, if reflectivity of the feedstock falls below a predetermined reflectivity threshold value. Still further, the controller can be configured to use both, reflectivity of the feedstock and weight of the feedstock simultaneously as the basis for the adjusting. For example, the controller 111 can comprise an artificial intelligence module configured to process values representative of or otherwise associated with reflectivity of the feedstock and values representative of or otherwise associated with weight of the feedstock to perform the adjusting of the composition of the reactants combination and/or the composition of the combustibles combination.

In some embodiments, the controller 111 is configured to control the first flow regulator 105 and the second flow regulator 110 in concert. At least one effect can be that the controller 111 can vary the ratio of an amount of the gaseous stream flowing from the first flow regulator 105 to an amount of the solids stream flowing from the second flow regulator 110 to the second chamber 140. In some embodiments, the controller 111 is configured to send a control signal (CS) to the first flow regulator 105, whereby the composition of the reactants combination and the combustibles combination can be adjusted. In some embodiments, the controller 11 is configured to send a control signal (CS) to the second flow regulator 110, whereby the composition of the reactants combination and the combustibles combination can be adjusted. In some embodiments, based on the control signal (CS) sent from the controller 111 to the first flow regulator 105, the flow regulator 105 is configured to adjust the composition of the reactants combination and the combustibles combination. In some embodiments, based on the control signal (CS) sent from the controller 111 to the second flow regulator 110, the second regulator 110 is configured to adjust the composition of the reactants combination and the combustibles combination.

In some embodiments, the flow regulators 105, 110 are configured to regulate the flow of solids stream and the gaseous stream, whereby the composition of the reactants combination and the combustibles combination can be adjusted. In some embodiments, the controller 111 is configured to output a signal to the first flow regulator 105 and to the second flow regulator 110. In some embodiments, the flow regulators 105, 110 are configured to regulate the flow of solids stream and the gaseous stream based on the control signal (CS) from the controller 111, whereby the composition of the reactants combination and the combustibles combination can be adjusted. At least one effect can be that the production of the hydrogen gas is optimized based on the quality and quantity of the feedstock.

In some embodiments, the flow regulators 105, 110 are electronic regulators, mechanical regulators, or a combination thereof. In some embodiments, the flow regulators 105, 110 are a set of valves configured to control the flow of fluids. In some embodiments, the flow regulators 105, 110 are a set of flaps configured to control the flow of fluids based on the output of the controller 111.

In some embodiments, the first flow regulator 105 is configured to regulate an amount of the gaseous stream flowing from the first flow regulator 105 to the second chamber 140. The amount of gaseous stream can be expressed in terms volume of gas at a given pressure per unit of time. At least one effect can be that the first flow regulator 105 can vary a ratio of the amount of gaseous stream to the amount of solids stream flowing to the second chamber 140. In some embodiments, the first flow regulator 105 is configured to regulate an amount of the gaseous stream flowing from the first flow regulator 105 to the third chamber 170. The amount of gaseous stream can be expressed in terms volume of gas at a given pressure per unit of time. At least one effect can be that the first flow regulator 105 can vary a ratio of the amount of gaseous stream to the amount of solids stream flowing to the third chamber 170.

In some embodiments, the second flow regulator 110 is configured to regulate an amount of the solids stream flowing from the second flow regulator 110 to the second chamber 140. The amount of solids stream can be expressed in terms of weight of solids per unit time. At least one effect can be that the second flow regulator 110 can vary a ratio of the amount of solids stream flowing to the second chamber 140. In some embodiments, the second flow regulator 110 is configured to regulate an amount of the solids stream flowing from the second flow regulator 110 to the third chamber 170. The amount of solids stream can be expressed in terms of weight of solids per unit time. At least one effect can be that the second to flow regulator 110 can vary a ratio of the amount of solids stream flowing to the third chamber 170.

In some embodiments, the system 100 may further comprise a sensor assembly 112. In some embodiments, the sensor assembly 112 is a mechanical sensor, an electronic sensor or a combination thereof. The sensor assembly 112 may comprise but not limited to a flow sensor, a pressure sensor, a temperature sensor, a Charge-Couple Device (CCD), a microelectromechanical (MEMS) system, or a combination thereof. In some embodiments, the sensor unit 112 is coupled to the controller 111. In some embodiments, the sensor assembly 112 is configured to send a signal (S) to the controller 111. In some embodiments, the sensor assembly 112 is coupled to the flow regulators 105, 110.

In some embodiments, the sensor assembly 112 is mounted in the vicinity of the first pyrolysis inlet 121. For example, the sensor assembly 112 is mounted at the first pyrolysis inlet 121. In some embodiments, the sensor assembly 112 or parts of the sensor assembly 112 are mounted in the vicinity of the first flow regulator 105 and the second flow regulator 110. For example, the sensor assembly 112 or parts of the sensor assembly 112 are mounted at the first flow regulator 105 and the second flow regulator 110.

In some embodiments, the sensor assembly 112 is configured for measuring the amount of heating value of the feedstock before the feedstock is fed into the first chamber 120. In some embodiments, the sensor assembly 112 is configured to output the values of the measurements to the controller 111. In some embodiments, the heating value of the feedstock is entered manually in the sensor assembly 112. In some embodiments, the sensor assembly 112 is configured to output the values to the controller 111.

In some embodiments, the sensor assembly 112 is configured to measure the amount of the gas coming out in the gaseous stream from the first chamber 120. In some embodiments, the sensor assembly 112 is configured to output the measurement values to the controller 111. In some embodiments, the sensor assembly 112 is configured to measure the amount of the solids portion coming out in the solids stream from the first chamber 120. In some embodiments, the sensor assembly 112 is configured to output the measurement values to the controller 111.

In some embodiments, the sensor assembly 112 is configured to output a sensor signal (S) indicative of the value of the process parameter to the controller 111. Based on the sensor signal (S) sent from the sensor assembly 112 to the controller 111, the controller 111 is configured to generate the control signal (CS) and output the control signal (CS) to the flow regulators 105, 110. In some embodiments, based on the control signal (CS) received from the controller 111, the first flow regulator 105 is configured to regulate the amount of the gaseous stream flowing out from the gaseous stream outlet 123. In some embodiments, based on the control signal (CS) received from the controller 111, the second flow regulator 110 is configured to regulate the amount of the solids stream flowing out from the solids stream outlet 124. Thus, the flow regulators 105, 111 can adjust the flow of the gaseous stream and the solids stream.

In some embodiments, the sensor assembly 112 is configured to output the measured values directly to the flow regulators 105, 110. In some embodiments, the sensor assembly 112 is configured to output a sensor signal indicative of the value of the process parameter to the flow regulators 105, 110 for adjusting the flow of the gaseous stream and the solids stream based on the sensor signal. In some embodiments, based on the sensor signal (S) from the sensor assembly 112, the first flow regulator 105 is configured to regulate the amount of the gaseous stream flowing out from the gaseous stream outlet 123. In some embodiments, based on the values received from the sensor assembly 112, the second flow regulator 110 is configured to regulate the amount of the solids stream flowing out from the solids stream outlet 124. In some embodiments, based on the heating value of the feedstock received from the sensor assembly 112, the second flow regulator 110 is configured to regulate the amount of the solids stream flowing out from the solids stream outlet 124. In some embodiments, based on the sensor signal (S), the second flow regulator 110 may regulate the amount of the solids stream flowing out from the solids stream outlet 124.

In some embodiments, the plurality of conduits 200 further comprises a conduit 200f. The conduit 200f is configured to couple the first flow regulator 105 to the second chamber 140. At least one effect can be that the gaseous stream of the thermally decomposed feedstock flows from the first flow regulator 105 to the second chamber 140. In some embodiments, the plurality of conduits 200 further comprises a conduit 200g. The conduit 200g is configured to couple the second flow regulator 110 to the second chamber 140. At least one effect can be that the solids stream of the thermally decomposed feedstock flows from the second flow regulator 110 to the second chamber 140. In some embodiments, the plurality of conduits 200 further comprises a conduit 200h. The conduit 200h is configured to couple the second flow regulator 110 to the third chamber 170. At least one effect can be that the solids stream of the thermally decomposed feedstock flows from the second flow regulator 110 to the third chamber 170. In some embodiments, the plurality of conduits 200 further comprises a conduit 200q. In one embodiment, the conduit 200q is configured to couple the first flow regulator 105 to the third chamber 170. In another embodiment, the conduit 200q is configured to couple the first flow regulator 105 to the conduit 200h. At least one effect can be that the gaseous stream of the thermally decomposed feedstock flows from the first flow regulator 105 to the third chamber 170.

In some embodiments, the second chamber 140 is adapted to perform an allothermal process. The allothermal process on the decomposed feedstock initiates the production of a product gas comprising the hydrogen. In some embodiments, the second chamber 140 is adapted to receive a first portion of the gaseous stream. In some embodiments, the second chamber 140 is further adapted to receive a first portion of the solids stream. At least one effect can be that, in the second chamber 140, the combination of the first portion of the gaseous stream and the first portion of the solids stream forms the reactants combination.

In some embodiments, the second chamber 140 is adapted to at least partially react the reactants combination with steam to produce a product gas comprising the hydrogen. In some embodiments, the second chamber 140 is configured to operate at a temperature of greater than 700° C. or in the range of from 700° C. to 1100° C. The second chamber 140 may be configured as a reactor. At least one effect can be that the gasification takes place inside the second chamber 120 by reacting the feedstock material with steam.

In some embodiments, the second chamber 140 comprises a first reformer inlet 141. In some embodiments, the first reformer inlet 141 is adapted to receive the gaseous portion of the thermally decomposed feedstock. In some embodiments, the first reformer inlet 141 is configured to allow the flow of the r gaseous portion of the thermally decomposed feedstock from the first flow regulator 105 into the second chamber 140 as the conduit 200f couples the first reformer inlet 141 to the first flow regulator 105. In some embodiments, the first reformer inlet 141 is adapted to receive the gaseous stream of the thermally decomposed feedstock directly from the first chamber 120 in addition to the reactants combination. Likewise, the first reformer inlet 141 may be adapted to receive the liquid stream of the thermally decomposed feedstock directly from the first chamber 120 in addition to the reactants combination. In another embodiment, the first reformer inlet 141 may also be adapted to receive the liquid stream of the thermally decomposed feedstock from an external source in addition to the reactants combination and/or in addition to the direct supply from the first chamber 120.

In some embodiments, the second chamber 140 further comprises a second reformer inlet 142. In some embodiments, the second reformer inlet 142 is adapted to receive the solids portion of the thermally decomposed feedstock. In some embodiments, the second reformer inlet 142 is adapted to intake solids stream of the thermally decomposed feedstock from the first flow regulator 105. In some embodiments, the second reformer inlet 142 is configured to allow the flow of the reactants combination comprising the solids portion of the thermally decomposed feedstock from the first flow regulator 105 into the second chamber 140 as the conduit 200g couples the second reformer inlet 142 to the first flow regulator 105. In some embodiments, the second reformer inlet 142 may also be adapted to intake solids stream of the thermally decomposed feedstock directly from the first chamber 120.

In some embodiments, the second chamber 140 further comprises a third reformer inlet 143. In some embodiments, the third reformer inlet 143 is adapted to intake steam from a heat exchanger 130. At least one effect can be that the reactants combination comprising solids stream, gaseous stream or the combination thereof may react with steam to produce a product gas comprising the hydrogen, like a synthesis gas.

In some embodiments, the second chamber 140 may further comprise a first reactor outlet 144. In some embodiments, the first reactor outlet 144 is adapted to discharge the product gas from the second chamber 140. At least one effect can be that the product gas obtained after gasification may flow out of the second chamber 140 via the first reactor outlet 144. In some embodiments, the second chamber 140 may further comprise a second reactor outlet 145. In some embodiments, the second reactor outlet 145 is adapted to allow discharge of the residual after gasification from the second chamber 140. At least one effect can be that the second chamber 140 is cleaned and is without residue or ash.

In some embodiments, the plurality of conduits 200 comprises a conduit 200i. In some embodiments, the conduit 200i is configured to couple the third reformer inlet 143 of the second chamber 140 to the heat exchanger 130. At least one effect can be that the third reformer inlet 143 intakes steam, flowing in the conduit 200i, from the heat exchanger 130 into the second chamber 140. In some embodiments, the plurality of conduits 200 further comprises a conduit 200j. The conduit 200j is configured to couple the first reactor outlet 144 to a gas cleaning chamber 150. At least one effect can be that the product gas undergoes a cleaning process, for example, synthesis gas cleaning process, to obtain a clean gas.

In some embodiments, the third chamber 170 is adapted to perform combustion. The third chamber 170 may be adapted to produce process heat from the combustion of fuel, the solid portion of the thermally decomposed feedstock, gaseous portion of the thermally decomposed feedstock, coke, or a combination thereof. In some embodiments, the third chamber 170 is adapted to receive a second portion of the gaseous stream. In some embodiments, the third chamber is adapted to receive a second portion of the solids stream. The combination of the second portion of the gaseous stream and the second portion of the solids stream forms a combustibles combination. The third chamber 170 is configured to work at a temperature of at least 1100° C., for example, at a temperature in a range of from 1100° C. to 1600° C. For example, the third chamber 170 may be configured as a combustion zone. Thus, at least one effect can be that the combustion of fuel can takes place inside the third chamber 170 and the produced process heat is used for the operations of the first chamber 120 and/or the second chamber 140.

In some embodiments, the third chamber 170 may comprise a first combustion inlet 171. In some embodiments, the first combustion inlet 171 is adapted to receive, through the conduit 200h, the solids stream of the thermally decomposed feedstock from the second flow regulator 110 into the third chamber 170. The solids stream may comprise pyrolysis coke/charcoal. In some embodiments, the first combustion inlet 171 is also adapted to receive, through the conduit 200h, the gaseous stream of the thermally decomposed feedstock from the first flow regulator 105 into the third chamber 170. In some embodiments, the first combustion inlet 171 is also adapted to receive, through a coupling between the conduit 200h and the conduit 200e, the additional feedstock in liquid, gaseous and/or solid state into the third chamber 170 for combustion.

In some embodiments, the third chamber 170 may further comprise a second combustion inlet 172. The second combustion inlet may be configured to receive residual gas after the extraction of hydrogen in the system 100. Thus, the rest gas is used for combustion. In some embodiments, the third chamber 170 may further comprise a first combustion outlet 173. The first combustion outlet 173 is configured to release ash or residual matter, after combustion of fuel, from the third chamber 170. In some embodiments, the third chamber 170 may further comprise a second combustion outlet 174. The second combustion outlet 174 may be adapted to allow the gaseous waste or the exhaust gas to leave the third chamber 170. At least one effect can be that the combustion chamber remains clean, which improves the effectiveness of the combustion chamber.

In some embodiments, the system 100 further comprises a heat exchanger 130. The heat exchanger 130 may be configured to perform heat extraction from the exhaust gases received at least from the third chamber 170. At least one effect can be that the heat is used in the first chamber 120 for thermal decomposition of the feedstock. In some embodiments, the heat exchanger 130 is configured to generate steam. In some embodiments, the heat exchanger 130 is configured to generate steam from water received from an external source. At least one effect can be that the steam is used in the second chamber 140 for gasification.

In some embodiments, the heat exchanger 130 may comprise a first exchanger inlet 131. The first exchanger inlet 131 may be adapted to intake exhaust from the third chamber 170. At least one effect can be that the heat from the exhaust is used to heat the water to generate steam. In some embodiments, the heat exchanger 130 may further comprise a second exchanger inlet 132. The second exchanger inlet 132 may be adapted to intake water to generate steam. At least one effect can be that the steam is generated for performing gasification process in the second chamber 140.

In some embodiments, the heat exchanger 130 may comprise a first exchanger outlet 133. In some embodiments, the first exchanger outlet 133 is configured to discharge heat. Since the conduit 200b couples the first exchanger outlet 133 to the second pyrolysis inlet 122, at least one effect can be that the heat from the first exchanger outlet 133 is used for thermal decomposition of the feedstock in the first chamber 120. In some embodiments, the heat exchanger 130 further comprises a second exchanger outlet 134. In some embodiments, the second exchanger outlet 134 is configured to discharge steam. At least one effect can be that the third reformer inlet 143 intakes steam, flowing through the conduit 200i, from the second exchanger outlet 134 of the heat exchanger 130 into the second chamber 140. In some embodiments, the heat exchanger 130 may further comprise a third exchanger outlet 135. In some embodiments, the third exchanger outlet 135 may be configured to discharge exhaust produced during the generation of steam from the heat exchanger 130

In some embodiments, the plurality of conduits 200 comprises a conduit 200k. In some embodiments, the conduit 200k is configured to couple the first exchanger inlet 131 to the second combustion outlet 174. At least one effect can be that the exhaust of the third chamber 170 flows from the third chamber 170 into the heat exchanger 130, which heats the water to generate steam from the exhaust. In some embodiments, the plurality of conduits 200 comprises a conduit 200l. In some embodiments, the conduit 200l is configured to couple the second exchanger outlet 134 to a reactor 180. At least one effect can be that the heat exchanger 130 forms a source of steam for the reactor 180 to perform a Water-gas shift reaction on the clean synthesis gas or on the product gas.

In some embodiments, the system 100 further comprises a cleaning chamber 150. The cleaning chamber 150 is adapted to clean the product gas, for example, the synthesis gas. The product gas obtained after gasification from the second chamber 140 undergoes a cleaning process in the cleaning chamber 150. In some embodiments, the raw synthesis gas from the second chamber 140 is cleaned in a synthesis gas cleaning system 150 and a clean synthesis gas is obtained. At least one effect can be that the product gas or the synthesis gas obtained from the gasification process is free of contaminants. For example, the product gas may be free of contaminants, such as particulates, sulfur, ammonia, carbon dioxide, chlorides, mercury and/or other trace metals.

In some embodiments, the cleaning chamber 150 comprises a cleaning inlet 151. The conduit 200j couples the cleaning inlet 151 of the cleaning chamber 150 to the first reformer outlet 144 of the second chamber 170. At least one effect can be that the product gas or the synthesis gas flows directly from the second chamber 140 to the cleaning chamber 150. In some embodiments, the cleaning chamber further comprises a cleaning outlet 152. The cleaning outlet 152 is adapted to release the clean gas from the cleaning chamber 150.

In some embodiments, the plurality of conduits 200 comprises a conduit 200m. The conduit 200m is configured to couple the cleaning outlet 152 of the cleaning chamber 150 to the reactor 180. At least one effect can be that the clean synthesis gas is discharged from the cleaning chamber 180 into the reactor 180.

According to some embodiments, the reactor 180 is adapted to perform a Water-Gas Shift Reaction (WGSR) on the cleaned product gas obtained from the cleaning chamber 150. At least one effect can be that the concentration of hydrogen in the clean product gas is increased. According to an alternative embodiment, the reactor 180 is adapted to perform a Water-Gas Shift Reaction (WGSR) directly on the product gas obtained from the second chamber 140. At least one effect can be that the concentration of hydrogen in the product gas is increased. The hydrogen rich synthesis gas may be used for fuel synthesis.

In some embodiments, the reactor 180 comprises a first reactor inlet 181. The conduit 200m is configured to couple the first reactor inlet 181 of the reactor 180 to the cleaning outlet 152 of the cleaning chamber 150. At least one effect can be that the synthesis gas flows out from the cleaning chamber 180 to the reactor 180. In an alternative embodiment, the conduit 200m is configured to couple the first reactor inlet 181 of the reactor 180 to the first reactor outlet 144 of the second chamber 140. At least one effect can be that the product gas obtained after gasification may flow out from the second chamber 140 directly to the reactor 180. In some embodiments, the reactor 180 further comprises a second reactor inlet 182. The conduit 200l is configured to couple the second reactor inlet 182 of the reactor 180 to the second exchanger outlet 134 of the heat exchanger 130. At least one effect can be that the steam flows out from the heat exchanger 130 into the reactor 180. In some embodiments, the reactor 180 further comprises at least one reactor outlet 183. At least one effect can be that the hydrogen rich synthesis gas flows out from the reactor 180 through the reactor outlet 183.

In some embodiments, the system 100 further comprises a hydrogen extraction chamber 190. The hydrogen extraction chamber 190 may be adapted to extract the hydrogen from the hydrogen-rich synthesis gas. For example, a pressure swing adsorption, a Liquid organic hydrogen carriers (LOHC) or any other known hydrogen extraction, or a bonding technique, may be used to extract hydrogen from the hydrogen-rich synthesis gas.

In some embodiments, the hydrogen extraction chamber 190 comprises at least one extraction inlet 191. The extraction inlet 191 is configured to intake the product gas rich in hydrogen from the reactor 180 into the hydrogen extraction chamber 190. In some embodiments, the hydrogen extraction chamber 190 further comprises a first extraction outlet 192. The first extraction outlet 192 is adapted to discharge the hydrogen out from the hydrogen extraction chamber 190. In some embodiments, the hydrogen extraction chamber 190 further comprises a second extraction outlet 193. The second extraction outlet 193 is adapted to discharge the rest gas from the hydrogen extraction chamber 190 to the third chamber 170. In some embodiments, a conduit 200p is provided between the hydrogen extraction chamber 190 to the third chamber 170. The conduit 200p may be configured to couple the second extraction outlet 193 of the hydrogen extraction chamber 190 to the second combustion inlet 172 of the third chamber 170. At least one effect can be that the rest gas discharged from the hydrogen extraction chamber 190 is re-used for the combustion process by the third chamber 170. The rest gases from the hydrogen extraction system may be used as an additional fuel in the multi-fuel burner.

In some embodiments, the plurality of conduits 200 comprises a conduit 200n. In some embodiments, the conduit 200n is configured to couple the extraction inlet 191 of the hydrogen extraction chamber 190 to the reactor outlet 183 of the reactor 180. At least one effect can be that the product gas rich in hydrogen flows from the reactor 180 into the hydrogen extraction chamber 190. In some embodiments, the conduit 200n is configured to couple the extraction inlet 191 of the hydrogen extraction chamber 190 to the reactor outlet 183 of the reactor 180, and to couple an external source of additional hydrogen to the reactor outlet 183 of the reactor 180. In some embodiments, the plurality of conduits 200 comprises a conduit 200r. The conduit 200r is configured to couple the external source of additional hydrogen the conduit 200n. At least one effect can be that the product gas rich in hydrogen is combined with additional hydrogen to improve the concentration of the hydrogen, and then the combined gas flows into the hydrogen extraction chamber 190.

In some embodiments, the conduit 200n is provided with an opening 211. The opening 211 is adapted to release at least some portion of the syngas rich in hydrogen for fuel synthesis purpose. At least one effect can be that the syngas rich in hydrogen may be used in the production of various gaseous or liquid fuels, or some chemicals.

According to another aspect of the present invention, the system 100 can be implemented in an apparatus. It is within the scope of the present disclosure that the skilled person can devise the apparatus for gasification of feedstock based on the disclosure of all the above-defined embodiments of the system 100. The apparatus can be implemented to at least some components of a system according to embodiments described above. For example, in one embodiment the apparatus comprises the first chamber 120 wherein the first chamber 120 is configured to perform pyrolysis on feedstock fed to the first chamber 120. At least one effect of the pyrolysis can be to thermally decompose the feedstock into a gaseous stream and a solids stream. Further, the apparatus comprises the second chamber 140, configured as a reformer chamber to perform reformation of a first portion of the gaseous stream combined in the second chamber 140 with a first portion of the solids stream, with steam, wherein the apparatus is configured for the first portion of the gaseous stream, the first portion of the solids stream and the steam to be separately fed to the second chamber 140 so as to form a reactants combination in the second chamber 140. Still further, the apparatus comprises the third chamber 170, configured as a combustion chamber to combust a second portion of the gaseous stream combined in the third chamber 170 with a second portion of the solids stream to produce heat, wherein the second portion of the gaseous stream and the second portion of the solids stream can be combined and fed to the third chamber 170 so as to form a combustibles combination in a conduit for combustibles to be fed into the third chamber 170. In one embodiment, the apparatus is configured for the second portion of the gaseous stream and the second portion of the solids stream to be separately fed to the third chamber 170 so as to form the combustibles combination only inside the third chamber 170. Thus, the system can be implemented in the apparatus so as to have different stages of gasification and hydrogen extraction take place within the apparatus.

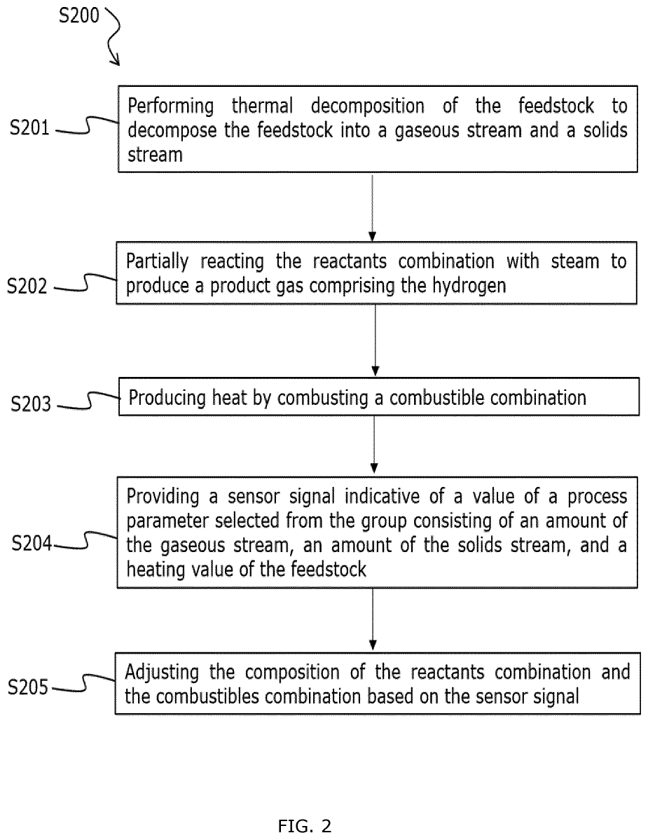

FIG. 2 is a flowchart that illustrates the method S200 of the gasification of feedstock according to an embodiment of the present disclosure. In some embodiments, the feedstock is provided by an external source for the thermal decomposition. The feedstock may comprise one or more from a group of fermentable, biomass-containing residual materials consisting of sewage sludge, biowaste or food waste, farm manure (liquid manure, dung), previously unused plants as well as plant parts (for example catch crops, plant residues and the like), specifically cultivated energy crops (renewable raw materials). In some embodiments, the thermal decomposition of the feedstock may be a pyrolysis process. The products obtained from the pyrolysis reaction comprises a gaseous stream and/or a solids stream. The gaseous stream may comprises a pyrolysis gaseous stream. The solids stream may comprises a pyrolysis coke stream.

In some embodiments, the method S200 comprises feeding feedstock to a pyrolysis chamber used for performing the thermal decomposition of the feedstock. The feedstock comprises organic material. In some embodiments, the method S200 includes performing thermal decomposition of the feedstock to decompose the feedstock into the gaseous stream and the solids stream S201. The combination of a first portion of the gaseous stream and a first portion of the solids stream forms a reactants combination. Likewise, the combination of a second portion of the gaseous stream and a second portion of the solids stream forms a combustibles combination.

In some embodiments, the method S200 further comprises performing an allothermal gasification process on the reactants combination S202. The gasification process takes place by at least partially reacting the reactants combination with steam to produce a product gas comprising the hydrogen. In some embodiments, the method S200 further comprises performing combustion on the combustibles combination S203. The combustion is performed to produce process heat at least for performing the thermal decomposition and/or for performing the allothermal gasification.

In some embodiments, the method S200 further comprises providing a sensor signal indicative of a value of a process parameter S204. In some embodiments, the process parameter is selected from the group consisting of an amount of the gaseous stream, an amount of the solids stream, and a heating value of the feedstock. In some embodiments, the method S200 further comprises measuring the amount of heating value of the feedstock, before the feedstock is fed into the first chamber. In some embodiments, the method S200 further comprises measuring the amount of the gas in the gaseous stream coming out from the first chamber. In some embodiments, the method S200 further comprises measuring the amount of the solids in the solids stream coming out from the first chamber. In some embodiments, the method S200 further comprises inputting the heating value of the feedstock manually.

In some embodiments, the method S200 comprises outputting a sensor signal (S) indicative of the value of the process parameter to the controller 111. Based on the sensor signal (S) sent from the sensor assembly 112 to the controller 111, generating the control signal (CS) and outputting the control signal (CS) to regulate the amount of the gaseous stream and to regulate the amount of the solids stream. Thus, the method S200 comprises adjusting the flow of the gaseous stream and the solids stream.

In some embodiments, the method S200 further comprises adjusting the composition of the reactants combination and the combustibles combination based on the sensor signal S205. In some embodiments, the method S200 comprises adjusting the composition of the reactants combination and the combustibles combination based on the process parameter. In some embodiments, the method S200 comprises adjusting the composition of the reactants combination and the combustibles combination based on the heating value of the feedstock. In some embodiments, the method S200 comprises adjusting the composition of the reactants combination and the combustibles combination based on the values received from the sensor.

In some embodiments, the method S200 further comprises, when the gaseous stream increases relative to the solids stream, increasing the ratio of the first portion of the gaseous stream in the reactants combination to the second portion of the gaseous stream in the combustibles combination, and/or, when the amount of the gaseous stream decreases relative to the solids stream, increasing the ratio of the second portion of the gaseous stream in the combustibles combination to the first portion of the gaseous stream in the reactants combination. In some embodiments, if a ratio of the non-biodegradable waste to biodegradable waste in the feedstock increases, the method comprises increasing the ratio of the first portion of the gaseous stream in the reactants combination provided in the chamber for gasification such as the second chamber 140 in the embodiments described above to the second portion of the gaseous stream in the combustibles combination provided in the third chamber 170 in the embodiments described above. Thereby, the method comprises increasing the ratio of the second portion of the solids stream in the combustibles combination to the first portion of the solids stream in the reactants combination. At least one effect can be that yield of the product gas is improved. Likewise, in some embodiments, if a ratio of the biodegradable waste to non-biodegradable waste in the feedstock increases, the method comprises increasing the ratio of the first portion of the solids stream in the reactants combination provided in the chamber for gasification such as the second chamber 140 in the embodiments described above to the second portion of the solids stream in the combustibles combination provided in the combustion chamber such as the third chamber 170 in the embodiments described above. Thereby, the method comprises increasing the ratio of the second portion of the gaseous stream in the combustibles combination to the first portion of the gaseous stream in the reactants combination. At least one effect can be that yield of the product gas is improved.

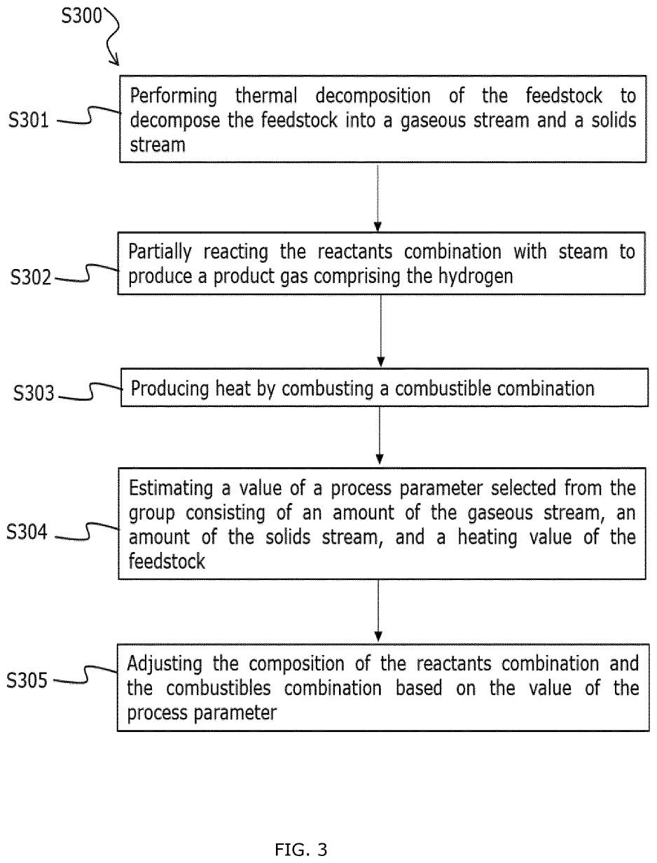

FIG. 3 is a flowchart that illustrates the method S300 of the gasification of feedstock according to an embodiment of the present disclosure. In some embodiments, the feedstock is provided by an external source for the thermal decomposition. The feedstock may comprise one or more from a group of fermentable, biomass-containing residual materials consisting of sewage sludge, biowaste or food waste, farm manure (liquid manure, dung), previously unused plants as well as plant parts (for example catch crops, plant residues and the like), specifically cultivated energy crops (renewable raw materials). In some embodiments, the thermal decomposition of the feedstock is a pyrolysis process. The products obtained from the pyrolysis reaction comprises a gaseous stream and/or a solids stream. The gaseous stream may comprises a pyrolysis gaseous stream. The solids stream may comprises a pyrolysis coke stream.

In some embodiments, the method S300 comprises feeding feedstock to a pyrolysis chamber used for performing the thermal decomposition of the feedstock. The feedstock comprises organic material. In some embodiments, the method S300 comprises performing thermal decomposition of the feedstock to decompose the feedstock into a gaseous stream and a solids stream S301. The combination of a first portion of the gaseous stream and a first portion of the solids stream forms a reactants combination. Likewise, the combination of a second portion of the gaseous stream and a second portion of the solids stream forms a combustibles combination.

In some embodiments, the method S300 comprises performing an allothermal gasification process on the reactants combination S302. The gasification process takes place by at least partially reacting the reactants combination with steam to produce a product gas comprising the hydrogen. In some embodiments, the method S300 comprises performing combustion on a combustibles combination S303. At least one effect can be that the combustion is performed to produce process heat at least for performing the thermal decomposition and/or for performing the allothermal gasification.

In some embodiments, the method S300 comprises estimating a value of a process parameter selected from the group consisting of an amount of the gaseous stream, an amount of the solids stream, and a heating value of the feedstock S304. In some embodiments, the method comprises measuring the amount of heating value of the feedstock, before the feedstock is fed into the first chamber. In some embodiments, the method comprises measuring the amount of the gas in the gaseous stream coming out from the first chamber. In some embodiments, the method comprises measuring the amount of the solids in the solids stream coming out from the first chamber.

The method S300 comprises adjusting the composition of the reactants combination and the combustibles combination based on the value of the process parameter S305. In some embodiments, the method S300 comprises adjusting the composition of the reactants combination and the combustibles combination based on the heating value of the feedstock. In some embodiments, the method S300 comprises adjusting the composition of the reactants combination and the combustibles combination based on the values received from the sensor.

In some embodiments, the method S300 further comprises, when the gaseous stream increases relative to the solids stream, increasing the ratio of the first portion of the gaseous stream in the reactants combination to the second portion of the gaseous stream in the combustibles combination, and/or, when the amount of the gaseous stream decreases relative to the solids stream, increasing the ratio of the second portion of the gaseous stream in the combustibles combination to the first portion of the gaseous stream in the reactants combination. In some embodiments, if a ratio of the non-biodegradable waste to biodegradable waste in the feedstock increases, the method comprises increasing the ratio of the first portion of the gaseous stream in the reactants combination provided in the chamber for gasification such as the second chamber 140 in the embodiments described above to the second portion of the gaseous stream in the combustibles combination provided in the third chamber 170 in the embodiments described above. Thereby, the method comprises increasing the ratio of the second portion of the solids stream in the combustibles combination to the first portion of the solids stream in the reactants combination. At least one effect can be that yield of the product gas is improved. Likewise, in some embodiments, if a ratio of the biodegradable waste to non-biodegradable waste in the feedstock increases, the method comprises increasing the ratio of the first portion of the solids stream in the reactants combination provided in the chamber for gasification such as the second chamber 140 in the embodiments described above to the second portion of the solids stream in the combustibles combination provided in the combustion chamber such as the third chamber 170 in the embodiments described above. Thereby, the method comprises increasing the ratio of the second portion of the gaseous stream in the combustibles combination to the first portion of the gaseous stream in the reactants combination. At least one effect can be that yield of the product gas is improved.

As used herein, the term ‘controller’ can refer to any known or later developed hardware, software, firmware, or combination thereof that is capable of performing the functionality associated herein with the controller. The controller can be provided as a distributed system that comprises a plurality of components which are provided in different locations that are spaced apart from one another such as a plurality of integrated circuit chips, microprocessor modules, and/or computers. For example, it is within the scope of the present disclosure that the functions performed by the first flow regulator and the second flow regulator may be performed by the controller.

As used herein, the term ‘reactants combination’ means gas, coke and/or other components provided in a reformer chamber for the gas, coke and/or other components to be reacted together in the reformer chamber. As used herein, the term ‘combustibles combination’ means a combination of gas, coke and/or other components provided in a combustion chamber for the gas, coke and/or other components to be combusted together in the combustion chamber.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein.

Although some drawings may be provided with exemplary dimensional statements, it should be understood that such statements are merely exemplary. Neither can any such statements be understood to be consistent from one drawing to another, nor should the statements be understood to limit the scope of the present disclosure to the stated dimensions or any combination or ratio thereof. The disclosure of dimensions should be understood merely to state an order of magnitude according to some embodiments. In particular, the invention can be implemented using, other orders of magnitude, other dimensions, other ratios of dimensions. Further, it should be understood that drawings are not drawn to scale.

The implementations herein are described in terms of exemplary embodiments. However, it should be appreciated that individual aspects of the implementations may be separately claimed and one or more of the features of the various embodiments may be combined.

1. A system for producing hydrogen from feedstock, the system comprising:
a first chamber adapted to thermally decompose the feedstock into a gaseous stream and a solids stream;
a second chamber adapted to receive a first portion of the gaseous stream and to receive a first portion of the solids stream to form a reactants combination, the second chamber further being adapted to at least partially react the reactants combination with steam to produce a product gas comprising the hydrogen;
a third chamber adapted to receive a second portion of the gaseous stream and to receive a second portion of the solids stream to form a combustibles combination, the third chamber further being adapted to at least partially combust the combustibles combination to produce process heat for the first chamber and/or the second chamber; and
a controller adapted to adjust the composition of the reactants combination and of the combustibles combination.

2. The system of claim 1, wherein the controller is configured to increase the ratio of the first portion of the gaseous stream in the reactants combination to the second portion of the gaseous stream in the combustibles combination when the gaseous stream increases relative to the solids stream, and/or wherein the controller is configured to reduce the ratio of solids stream in the reactants combination to solids stream in the combustibles combination when the solids stream decreases relative to the gaseous stream.

3. The system of claim 1, wherein the controller is configured to increase the ratio of the second portion of the gaseous stream in the combustibles combination to the first portion of the gaseous stream in the reactants combination when the gaseous stream decreases relative to the solids stream, and/or wherein the controller is configured to reduce the ratio of solids stream in the combustibles combination to solids stream in the reactants combination when the solids stream increases relative to the gaseous stream.

4. The system of claim 1, wherein the gaseous stream comprises pyrolysis gas and the solids stream comprises pyrolysis coke.

5. The system of claim 1, further comprising a heat exchanger coupled to the first chamber and to the second chamber, wherein the heat exchanger is configured to produce steam for use in the second chamber and to produce heat for use in the first chamber.

6. The system of claim 1, further comprising: a reactor adapted to perform a Water-Gas Shift Reaction (WGSR) on the product gas to increase the concentration of hydrogen in the product gas, thereby forming a hydrogen-rich product gas.

7. The system of claim 1, further comprising:
an extraction chamber adapted to be coupled to the reactor to receive the product gas and form a hydrogen stream and a byproduct gas stream.

8. The system of claim 1, wherein the controller is configured to estimate a change of a value of a process parameter selected from the group consisting of an amount of the gaseous stream, an amount of the solids stream, and a heating value of the feedstock, and wherein the controller is further adapted to perform the adjusting of the composition of the reactants combination and of the combustibles combination based on the change of the process parameter value.

9. The system of claim 1, further comprising a sensor unit coupled to the controller and configured to output a sensor signal indicative of the value of the process parameter to the controller, and wherein the controller is configured to derive a control signal based on the sensor signal.

10. The system of claim 9, wherein the sensor unit comprises at least one of a group consisting of a flow sensor, a pressure sensor, a temperature sensor, a charge-coupled device, CCD, and a microelectromechanical system, MEMS.

11. The system of claim 1, wherein the controller is configured to select, based on the process parameter value, another process parameter and to estimate another process parameter value of the another process parameter.

12. The system of claim 1, wherein the first chamber, the second chamber, the third chamber, the heat exchanger, the reactor, and the extraction chamber are coupled to each other via conduits.

13. A method for extracting hydrogen from feedstock comprising:
performing thermal decomposition of the feedstock to decompose the feedstock into a gaseous stream and a solids stream;
at least partially reacting a reactants combination with steam to produce a product gas comprising the hydrogen, wherein the reactants combination is composed of at least a first portion of the gaseous stream and a first portion of the solids stream;
producing heat by at least partially combusting a combustibles combination for performing the thermal decomposition and/or for the at least partially reacting the reactants combination with steam, wherein the combustibles combination is composed of at least a second portion of the gaseous stream and a second portion of the solids stream;
providing a sensor signal indicative of a value of a process parameter selected from the group consisting of an amount of the gaseous stream, an amount of the solids stream, and a heating value of the feedstock; and
adjusting the composition of the reactants combination and the combustibles combination based on the sensor signal.

14. A method for extracting hydrogen from feedstock comprising:
performing thermal decomposition of the feedstock to decompose the feedstock into a gaseous stream and a solids stream;
at least partially reacting a reactants combination with steam to produce a product gas comprising the hydrogen, wherein the reactants combination is composed of at least a first portion of the gaseous stream and a first portion of the solids stream;
producing heat by combusting a combustibles combination for performing the thermal decomposition and/or for at least partially reacting the reactants combination with steam, wherein the combustibles combination is composed of at least a second portion of the gaseous stream and a second portion of the solids stream;
estimating a value of a process parameter selected from the group consisting of an amount of the gaseous stream, an amount of the solids stream, and a heating value of the feedstock; and
adjusting the composition of the reactants combination and the combustibles combination based on the value of the process parameter.

15. The method of claim 13, further comprising: increasing the ratio of the first portion of the gaseous stream in the reactants combination to the second portion of the gaseous stream in the combustibles combination when the gaseous stream increases relative to the solids stream, and decreasing the ratio of the first portion of the gaseous stream in the reactants combination to the second portion of the gaseous stream in the combustibles combination when the gaseous stream decreases relative to the solids stream; and/or increasing the ratio of the second portion of the gaseous stream in the combustibles combination to the first portion of the gaseous stream in the reactants combination when the gaseous stream decreases relative to the solids stream, and decreasing the ratio of the second portion of the gaseous stream in the combustibles combination to the first portion of the gaseous stream in the reactants combination when the gaseous stream increases relative to the solids stream.

16. The method of claim 13, further comprising:
feeding feedstock to a pyrolysis chamber used for performing the thermal decomposition of the feedstock, wherein the feedstock comprises organic material.
